(19) United States
(12) Patent Application Publication
(10) Pub. No.: US 2025/0267556 A1
(43) Pub. Date: Aug. 21, 2025

(54) RESELECTION ASSISTANCE FOR ON-DEMAND SYSTEM INFORMATION

(71) Applicant: Lenovo (United States) Inc., Morrisville, NC (US)

(72) Inventor: Prateek BASU MALLICK, Dreieich (DE)

(21) Appl. No.: 19/202,838

(22) Filed: May 8, 2025

(51) Int. Cl. H04W 48/08; H04W 36/08

(52) U.S. Cl. CPC H04W 48/08; H04W 36/08

(57) ABSTRACT

Various aspects of the present disclosure relate to providing reselection assistance information to a user equipment (UE), where an anchor cell (or serving cell) provides a request configuration to the UE that contains some information from a master information block (MIB) of a target cell and/or system information from the target cell. For example, the request configuration may include barring information from within the MIB of the target cell and a portion of system information associated with the target cell as being a cell suitable and/or accessible to the UE.

### TECHNICAL FIELD

The present disclosure relates to wireless communications, and more specifically to managing (e.g., selecting, obtaining, reselecting) on-demand system information (SI) acquisition.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.

As used herein, including in the claims, a “set” may include one or more elements.

The present disclosure relates to methods, apparatuses, processors, and systems that supports the provisioning of SI for enabling on-demand SI (e.g., one or more system information blocks (SIBs)) for a network energy saving (NES) cell. The methods, apparatuses, processors, and systems of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may comprise one or more memories and one or more processors coupled with the one or more memories and individually or collectively configured to cause the UE to receive a SIB from a first cell, wherein the SIB includes one or more of barring information associated with a second cell or SIB1-related information associated with the second cell and transmit a SIB1 request to the second cell based at least in part on the received SIB from the first cell.

A processor for wireless communication is described. The processor may be configured to, capable of, or operable to perform one or more operations as described herein. For example, the processor may comprise one or more memories and one or more controllers coupled with the one or more memories and individually or collectively configured to cause the processor to receive a SIB from a first cell, wherein the SIB includes one or more of barring information associated with a second cell or SIB1-related information associated with the second cell and transmit a SIB1 request to the second cell based at least in part on the received SIB from the first cell.

A method performed or performable by the UE is described. The method may comprise receiving a SIB from a first cell, wherein the SIB includes one or more of barring information associated with a second cell or SIB1-related information associated with the second cell and transmitting a SIB1 request to the second cell based at least in part on the received SIB from the first cell.

In some implementations of the UE, processor, and method described herein, the SIB is different than a SIB1, and wherein the SIB comprises a SIB1 request configuration.

In some implementations of the UE, processor, and method described herein, the barring information associated with the second cell corresponds to information included in a master information block (MIB) of the second cell.

In some implementations of the UE, processor, and method described herein, the UE, processor, and method may further be configured to, capable of, performed, performable, or operable to determine that the second cell is not barred based at least in part on the received SIB from the first cell including the barring information associated with the second cell, wherein the SIB1 request is transmitted to the second cell based at least in part on the second cell not being barred.

In some implementations of the UE, processor, and method described herein, the UE, processor, and method may further be configured to, capable of, performed, performable, or operable to receive the SIB from the first cell during a cell reselection procedure.

In some implementations of the UE, processor, and method described herein, wherein the received SIB from the first cell further includes an infra-frequency reselection indicator (IFRI), the UE, processor, and method may further be configured to, capable of, performed, performable, or operable to determine whether the UE is allowed to reselect one or more other cells on a same frequency as the second cell based at least in part on the IFRI and refrain from transmission of one or more SIB1 requests to the one or more other cells based at least in part on the UE not being allowed to reselect one or more other cells on the same frequency as the second cell.

In some implementations of the UE, processor, and method described herein, the SIB1-related information comprises one or more of a public land mobile network (PLMN) identifier, a standalone non-public network (SNPN) identifier, a closed access group identifier (CAG ID), or a tracking area (TA) identifier.

In some implementations of the UE, processor, and method described herein, the UE, processor, and method may further be configured to, capable of, performed, performable, or operable to determine that the second cell is an NES cell, wherein the SIB1 request is transmitted to the second cell based at least in part on the second cell being the NES cell.

In some implementations of the UE, processor, and method described herein, the UE, processor, and method may further be configured to, capable of, performed, performable, or operable to receive SIB1 from the second cell based at least in part on the transmitted SIB1 request and camp on the second cell based at least in part on the received SIB1 from the second cell.

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to receive an indication of a cell reselection procedure for a UE and transmit, to the UE, a SIB, wherein the SIB includes one or more of barring information associated with a cell or SIB1-related information associated with the cell.

A method performed or performable by the network entity is described. The method may comprise receiving an indication of a cell reselection procedure for a UE and transmitting, to the UE, a SIB, wherein the SIB includes one or more of barring information associated with a cell or SIB1-related information associated with the cell.

In some implementations of the network entity and method described herein, the network entity is an anchor cell.

In some implementations of the network entity and method described herein, the network entity is a serving cell.

In some implementations of the network entity and method described herein, the cell is an NES cell.

In some implementations of the network entity and method described herein, the SIB is different than a SIB1, and wherein the SIB comprises a SIB1 request configuration.

In some implementations of the network entity and method described herein, the barring information associated with the second cell corresponds to information included in a MIB of the second cell.

In some implementations of the network entity and method described herein, the SIB1-related information comprises one or more of a public land mobile network (PLMN) identifier, a standalone non-public network (SNPN) identifier, a closed access group identifier (CAG ID), or a tracking area (TA) identifier.

In some implementations of the network entity and method described herein, the SIB1-related information associated with the cell includes a bit that identifies whether there are differences between a subset of information elements (IEs) in a SIB1 of the cell and a subset of IEs in the SIB1 of the network entity, and wherein the subset of IEs includes IEs that contain public land mobile network (PLMN) identifiers, tracking area identifiers, or private network identifiers.

In some implementations of the network entity and method described herein, the SIB1-related information associated with the cell includes a bitmap that identifies the differences between the subset of IEs in the SIB1 of the cell and the subset of IEs in the SIB1 of the network entity.

### BRIEF DESCRIPTION OF THE DRAWINGS

FIGS. 1 and 2 illustrate an example of a wireless communications system in accordance with aspects of the present disclosure.

FIG. 3 illustrates an example signaling diagram in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

### DETAILED DESCRIPTION

In a wireless communication system, network energy consumption may be reduced through on-demand provisioning of SI (e.g., via SIB1) of a cell (or another NE) to a UE, such as during a cell reselection procedure. In some cases, the wireless communications system may support on-demand SIB1 for a UE in an idle mode and/or an inactive mode (also referred to as a radio resource control (RRC) idle mode or an RCC inactive mode). For example, a UE may receive information for cell access for a target cell (e.g., a NES cell) via information (e.g., a SIB1 request configuration) received from another cell (e.g., a serving cell or an anchor cell). A serving cell may be a cell on which the UE is camped on. An anchor cell may be a cell (e.g., non-serving cell) that assists the UE with access to another cell by providing information (such as SIB1 request configuration) to the UE. Alternatively, in some cases, the anchor cell may the serving cell of the UE.

The UE may process the received information to determine whether the target cell is capable of providing service to the UE. However, providing the information for cell access alone may be insufficient in preventing the UE from attempting to access the cell that is unable to properly serve the UE (e.g., the cell may be associated with a different network operator than the UE, the cell may lack support for a certain radio access technology, and so on). Additionally, providing extra information (e.g., PLMN information for all candidate cells) may result in increased signaling overhead within the wireless communications system, significantly increasing the network energy consumption for cells associated with the UE. Thus, it may be desirable for the wireless communications system to balance the provisioning of information to the UE with the resulting signaling overhead, in order to effectively reduce the SIB1 requests transmitted by the UE.

Various aspects of the present disclosure relate to providing assistance information (e.g., for cell reselection) to a UE, where an anchor cell (or a serving cell) provides (e.g., transmits) to the UE a subset of information from a MIB of a target cell and/or a subset of information from a SIB1 of the target cell. For example, information may include barring information from the MIB of the target cell and/or a subset of SIB1-related information of the target cell (e.g., a PLMN identifier, an SNPN identifier, a CAG identifier, or a tracking area (TA) identifier). Thus, the UE may receive information effective for determining whether a target cell is accessible, and based on the information, transmit a SIB1 request to the target cell to initiate a random access procedure with the target cell (e.g., to request SIB1 from the target cell).

The UE may, as a result, avoid transmitting SIB1 requests to cells that are inaccessible by the UE, thereby reducing signaling overhead and energy consumption, among other benefits. Put another away, by enabling an anchor cell (or serving cell) to provide information associated with another cell (e.g., a candidate cell, a target cell, or a NES cell), processing at both the UE and the other cell may be reduced. For example, if the other cell is incapable of providing service to the UE, the UE can avoid attempting to access the cell (e.g., through messaging, signaling), as the UE is already aware (e.g., identified) that the cell is not suitable for camping. As a result, unnecessary signaling between the UE and the other cell can be avoided, thereby reducing energy consumption for both. Additionally, or alternatively, if the information provided by the anchor cell (or the serving cell) indicates that the other cell is capable of serving the UE, the UE and the other cell may experience improved coordination (e.g., the UE may request SIB1, the cell may allocate resources appropriately).

Aspects of the present disclosure are described in the context of a wireless communications system.

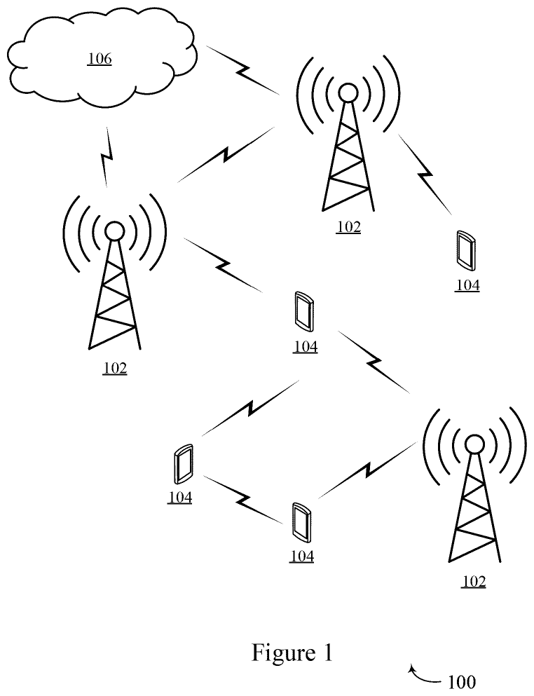

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (M M E), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 KHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 M Hz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 KHz subcarrier spacing. FR2 may be associated with one or multiple numerologies (e.g., at least 2 numerologies). For example, FR2 may be associated with a third numerology (e.g., μ=2), which includes 60 KHz subcarrier spacing; and a fourth numerology (e.g., μ=3), which includes 120 kHz subcarrier spacing.

The wireless communications system 100, including one or more of the NE 102, the UE 104, or the CN 106 may enable the provisioning of reselection assistance information to the UE 104, where an anchor cell (or a serving cell) provides information (e.g., a SIB1 request configuration) to the UE 104, in which the information includes a subset (e.g., portion) of information from a MIB of a target cell and/or a subset of SIB1-related information of the target cell.

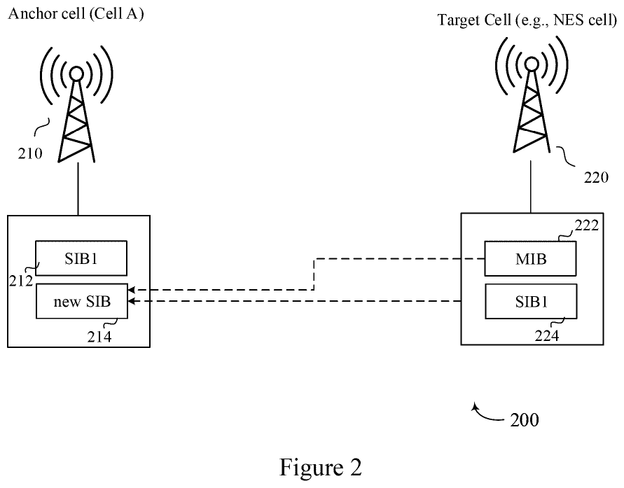

FIG. 2 illustrates an example wireless communication system 200 in accordance with aspects of the present disclosure. The wireless communication system 200 may implement or be implemented by aspects of the wireless communications system 100. For example, the wireless communication system 200 may include an anchor cell 210 and a target cell 220, which may be examples of the corresponding NEs as described with reference to FIG. 1. In some examples, the anchor cell 210 may be a non-serving cell of a UE, which may be examples of the corresponding UEs as described with reference to FIG. 1. In some other examples, the anchor cell 210 may be a serving cell of a UE, which may be examples of the corresponding UEs as described with reference to FIG. 1.

One or more of the anchor cell 210 or the target cell 2220 may support transmission and reception of SI, such as MIB and SIB. For example, the anchor cell 210 may transmit a SIB1 212, and the target cell 220 may transmit a MIB 222 and a SIB1 224. In the example of FIG. 2, the anchor cell 210 may transmit information in a SIB 214, which may include a subset of information of the MIB 222 and/or a subset of information of the SIB1 224 associated with the target cell 220 for cell reselection. The SIB 214 may be different than a SIB1. Additionally, or alternatively, the SIB 214 may be different than one or more other SIBs (e.g., SIB2 through SIB21). Put another way, the SIB 214 may be a new SIB configured to provide the subset of information of the MIB 222 and/or the subset of information of the SIB1 224 associated with the target cell 220 for cell selection and/or cell reselection.

The subset of information of the MIB 222 may include barring information. The barring information may indicate a status of the target cell 220, such as whether the target cell 220 is barred. For example, the barring information may be an information element (IE) in the SIB 214 that may indicate (e.g., via a bit, flag) whether the target cell 220 is barred or not barred. A barred cell is a cell a UE it not allowed to camp on. If the target cell 220 is not barred, a UE may handle the cell as a candidate during a cell selection and/or cell reselection procedure. Additionally, or alternatively, the subset of information of the MIB 222 may include INFI information. The INFI information may be an IE in the SIB 214 that may indicate whether selection of another cell is allowed or not allowed. For example, if the INFI information indicates that selection is allowed, a UE may select another cell operating on a same frequency as the barred cell as a candidate for cell selection and/or cell reselection. Otherwise, if the INFI information indicates not allowed, the UE may refrain (e.g., avoid, skip) the cell operating on the same frequency as the barred cell as a candidate for cell selection and/or cell reselection.

Additionally, or alternatively, the subset of information of the SIB1 224 associated with the target cell 220 may include a PLMN identifier, an SNPN identifier, a CAG identifier, a TA identifier, and so on. A UE may determine the target cell 220 is accessible based on the identifiers, as described herein. Accordingly, a UE may initiate random access with the target cell 220 based at least in part on the subset of information of the MIB 222 and/or the subset of information of the SIB1 224 associated with the target cell 220.

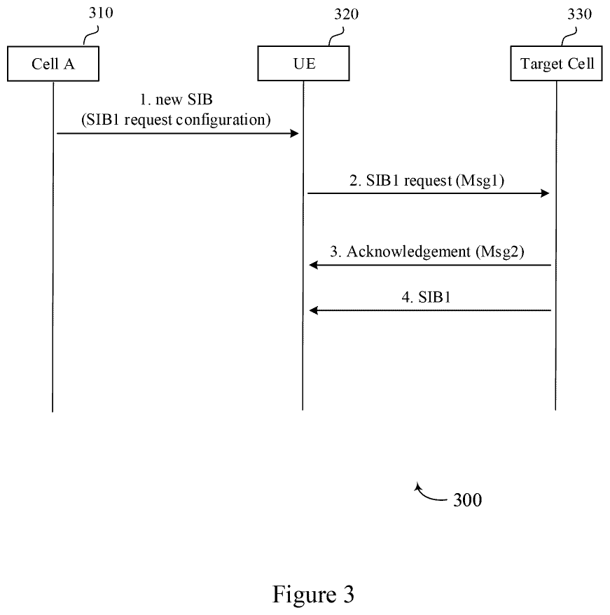

FIG. 3 illustrates an example of a signaling diagram 300 in accordance with aspects of the present disclosure. The signaling diagram 300 may implement various aspects of the present disclosure described herein. For example, the signaling diagram 300 may include an anchor cell 310 (e.g., a first cell), a UE 320, and a target cell 330 (e.g., a second cell), which may be examples of NEs and UEs as described herein. In the following description of the signaling diagram 300, the operations between the anchor cell 310, the UE 320, and/or the target cell 330 may be performed in different orders or at different times. Some operations may also be omitted, or other operations may be added.

The target cell 330 (e.g., an NES cell or other second cell, such as a gNB) may support on-demand SIB to decrease energy consumption. In some examples, the target cell may support transmission of on-demand SIBs in response to receiving a SIB1 (e.g., an on-demand SIB (OD-SIB1)) request from the UE 320. The transmission of the OD-SIB1 request by the UE 310 may be supported in various RRC modes (e.g., an RRC idle mode, an RRC inactive mode, and RRC connected mode). In some cases, the transmission of the OD-SIB1 request by the UE 310 may be based at least in part on a timer. For example, the UE 320 may start (e.g., activate, enable, trigger) a T311 timer in response to the UE 320 detecting a connection failure, or the like. The T311 timer may be associated with a duration, in which the UE 320 awaits to attempt certain recovery actions (e.g., cell reselection) after the connection failure. If the T311 timer expires before the UE 320 can successfully recover (e.g., reestablish a connection or camp on another cell, such as the target cell 330), the UE 320 may fall back to the RRC idle mode.

At step 1, the anchor cell 310 (e.g., a first cell) transmits a new SIB to the UE 320. The new SIB includes a SIB1 request configuration, which contains information associated with the target cell 330 (e.g., the information from the MIB 222 and/or SIB1 224 of the target cell 220). In some cases, the new SIB may include request configurations for multiple cells, include a request configuration for the target cell 330 (e.g., a gNB that supports network energy saving), the anchor cell 310 (e.g., a gNB periodically transmitting its SIB1), or other cells (e.g., any cell periodically providing SIB1)

At step 2, the UE 320, using the SIB1 request configuration, transmits a SIB1 request (e.g., an OD-SIB1 request) to the target cell 330. For example, the UE 320 determines the target cell 330 is suitable for access based on the contents of the SIB request configuration and transmits an OD-SIB1 request (e.g., an uplink wakeup signal (UL WUS)), using a Msg1 to the target cell 330. The UE 320 may determine whether the target cell is barred, or not barred, for the UE 320 based on the contents of the SIB request configuration (e.g., the PLMN ID is the home PLMN of the UE 320, the tracking area is not on a forbidden list, and so on). Via the Msg1, the UE 320 initiates a random access procedure (e.g., a random access channel (RACH) procedure) with the target cell 330.

At step 3, the target cell 330 transmits an acknowledgment message. For example, the target cell 330 sends a Msg2 to the UE 320 to acknowledge the reception of the OD-SIB1 request. At step 4, the target cell transmits a SIB1 to the UE 320.

In some examples, the UE 320 may follow and/or implement a cell reselection procedure that evaluates a suitability (e.g., Srxlev and Squal) of the target cell 330 after receiving parameters or other information from the anchor cell 310, and then uses the parameters of the target cell 330, such as parameters (e.g., SIB1, SIB2) within the SIB1 request configuration, to verify cell selection criteria (e.g., an absolute priority reselection criteria) for the target cell 330.

In some examples, the SIB1 request configuration provides barring information (e.g., cellbarred and/or intraFreqReselection information) from the MIB 222 of the target cell 220 (e.g., target cell 330). The MIB 222 (or physical broadcast channel (PBCH) may contain the following information:

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}

In some examples, the MIB may include information in addition to feature specific barring bits. For example, while some features may ignore any MIB cellBarred bit, such as NTN, air-to-ground (ATG), integrated access and backhaul mobile terminal (IAB-MT), network controlled repeaters (NCR-MT), and so on, other features use the MIB cellBarred bit, such as when cellBarredFeature is not broadcast in SIB1 (e.g., via cellBarredNES). Thus, the MIB cellBarred may be used by devices (e.g., the UE 320) to determine whether a cell is suitable or accessible, and the cellBarred may be useful as barring information for the UE 320 when determining whether to send an OD-SIB1 request to a cell (e.g., the target cell 330).

The MIB cellBarred information is useful for determining whether to transmit an OD-SIB1 request for a variety of reasons. First, with respect to emergency calls, the MIB cellBarred information, set to barred, prohibits emergency calls, and the UE 320 should not access the cell that does not support emergency call. Second, feature-specific devices also utilize MIB cellBarred information. For example, certain features utilize the MIB cellBarred bit when an associated cellBarredFeature is not broadcast in SIB1 (e.g., cellBarredNES). Third, some devices are not feature-specific, and utilize the MIB cellBarred information to determine if certain features are to be provided service in a potential target cell.

In some cases, the anchor ell 310 may include the SIB1 request configuration for neighbor cells that are not MIB barred. When the cellBarred information of the MIB of the target cell 330 is set to “barred,” the SIB1 request configuration may include the SIB1 request configuration when the target cell 330 is an NTN cell (and not include other information, such as a physical random access channel (PRACH) configuration/resources). Thus, when the cellBarred information is set to “barred,” other configuration information is to be included for an NTN cell (and not another target cell).

Providing the MIB cellBarred information to the UE 320 via the SIB1 request configuration (e.g., at Step 1) may enable the UE 320 to receive the MIB information for the target cell 330 during a reselection procedure (e.g., during the evaluation) and without the UE 320 performing other procedures, such as synchronization signal block (SSB) measurement.

For example, while the MIB/PBCH may be embedded around synchronization signals of an SSB, the UE 320 may be evaluating many possible cells (e.g., neighboring cells), and acquiring the MIB of many cells may lead to increased latency and overhead. The UE 320 may reduce the latency (e.g., a delay due to waiting for an SSB burst from a cell), by using a PBCH demodulation reference signal (DMRS). When extracting PBCH DMRS resource elements (REs), the UE 320 applies a fast Fourier transform (FFT) for each PBCH symbol (DM RS exists in every PBCH symbol). However, the UE 320 may not support the use of FFT, or the use of PBCH DMRS measurements, and thus the UE 320 may only acquire the MIB and SIB1 for a best cell or highest ranked cell on a frequency (e.g., the target cell 330), such as during a final check of the random access procedure.

The UE 320, therefore, may receive the cellBarred information from the MIB of the target cell 330 (e.g., the MIB 222 of the target cell 220) via the SIB1 request configuration. Also, since intraFreqReselection information, or IFRI, may be associated with the cellBarred information in theMIB, the SIB1 request configuration may include both information bits. For example, setting the intraFreqReselection to “not allowed” may enable or cause the UE 320 to refrain from requesting the SIB1 from any/all cells of a frequency of the target cell 330 associated with the SIB1 request configuration. Thus, the UE 320 may determine whether it is allowed to reselect one or more other cells on a same frequency as the target cell 330 based at least in part on the IFRI; and refrain from transmitting SIB1 requests to other cells when the UE is not allowed to reselect other cells on the same frequency as the target cell 330.

In some examples, the SIB1 request configuration (e.g., in the new SIB 214) may include PLMN IDs, a CAG List, SNPNs, tracking area information, and so on. The UE 320, as described herein, may use the information when determining whether to select a cell (e.g., the target cell 330) for a random access procedure.

For example, a highest ranked cell or best cell, according to absolute priority reselection rules, may be an intra-frequency or inter-frequency cell not suitable for the UE 320. For example, the cell (1) may belong to a PLMN that is not indicated as being equivalent to a registered PLMN, (2) may be a CAG cell that belongs to a PLMN that is equivalent to the registered PLMN but with no CAG-ID that is present in the allowed CAG list, for the UE 320, being broadcasted, (3) is not a CAG cell and the CAG-only indication in the UE 320 is set, and/or (4) does not belong to an SNPN that is equal to or indicated as being equivalent to a registered or selected SNPN of the UE 320 in SNPN access mode. In such cases, the UE 320 may not consider the cell, for operation in licensed spectrum, as a candidate for a reselection procedure. As another example, the highest ranked cell or best cell according to absolute priority reselection rules is an intra-frequency or inter-frequency cell may not be suitable for the UE 320 due to being part of a “list of 5GS forbidden TAs for roaming.”

In some examples, information (e.g., CellAccessRelatedInfo) from the SIB1 of the target cell 330 (e.g., the SIB1 224 of the target cell 220) may identify an otherwise highest ranked cell or best cell as a cell that is unsuitable for the UE 320. However, in some cases, providing such information may lead to inefficient and/or increased signaling, as the information may exceed 1000 bits ((24 bits TAC+44 NID bits)*12+other Info), especially when additional information (e.g., cellReservedForOtherUse, cellReservedForFutureUse, imsEmergencySupportForSNPN) is provided to the UE 320.

Thus, the SIB1 request configuration may identify differences between SIB1 information in the target cell 330 and the anchor cell 310 and signal a differential or other indicator that identifies the differences between the cells in a new SIB (e.g., the new SIB 214). For example, when all PLMN information is the same between the cells, the SIB1 request configuration may indicate that all PLMNs are the same (e.g., using one bit set to TRUE).

However, the when the PLMN information is different, the SIB1 request configuration provides such as indication (e.g., the one bit is set to FALSE), as well as further information (e.g., a bitmap) that indicates the PLMN IDs from the anchor cell 310 that are not present in the SIB1 of target cell 330. For example, a 12-bit bitmap may include one bit for each of the maximum 12 PLMNs included by any cell. Thus, the PLMN IDs (or other SIB1 information) present in the SIB1 of the target cell 320, but not in the SIB1 (e.g., SIB1 212) of the anchor cell 310, may be explicitly and fully included in the SIB1 request configuration for the target cell 330.

As an example, the bitmap (or indication) may indicate that there is at least one additional PLMN included in the SIB1 of target cell 330 that is not in the SIB1 212 of the anchor cell 310. The anchor cell 310 may include four PLMN IDs are included (e.g., in the order of occurrence within the SIB1, such as A, B, C, and D). The target cell 320 may include five 5 PLMN IDs (e.g., A, B, E, F, and G). The indication may identify the following: all the PLMNs are the same between the two cells: False (11000000 000 0) 1 and a number of additional PLMNs in the target cell 330: three (along with a list of the three PLMN IDS-E, F, and G). Thus, the indication may identify and/or include a delta or difference in the contents, wherein an index of the anchor cell 310 is used by the target cell 330 to identify an earlier cell as a basis cell.

Thus, the SIB1 request configuration may include a bit that identifies whether there are differences between a subset of information elements (IEs) in the SIB1 of the target cell and a subset of IEs in the SIB1 for the network entity, and wherein the subset of IEs includes IEs that contain PLMN identifiers, tracking area identifiers, private network identifiers, and so on.

In some examples, the SIB1 request configuration (e.g., an IFRI bit) may be provided only for an accessible (e.g., not barred, or MIB notBarred) neighbor cell and/or an NTN cell. Thus, the SIB1 request configuration may not be provided for any MIB barred neighbor cells, since the cells are barred from providing service to the UE 320. For example, even if the neighbor cell is an NTN Cell, where NTN UEs may ignore MIB barring bits), the SIB1 request configuration may not include the MIB barring bit, because other bits (e.g., cellBarredNTN-r17) may indicate to the NTN UE that NTN access is allowed (assuming the cellBarredNTN-r17 bit is included in the configuration. Thus, the UE 320 may transmit the SIB1 request without using information from the MIB.

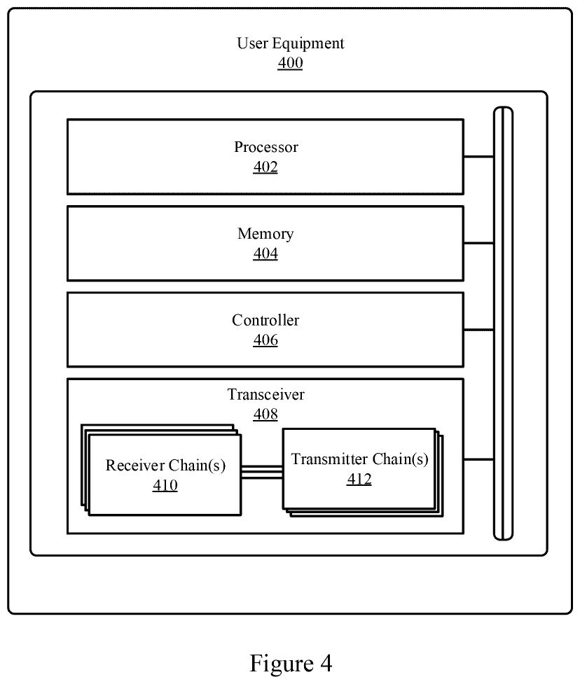

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (A SIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for receiving a SIB from a first cell, wherein the SIB includes one or more of barring information associated with a second cell or SIB1-related information associated with the second cell and transmitting a SIB1 request to the second cell based at least in part on the received SIB from the first cell.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 510, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

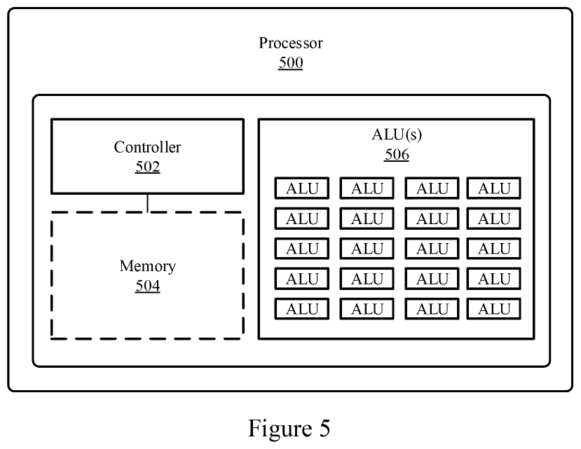

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALU s 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. For example, the processor 500 may be configured to support a means for receiving a SIB from a first cell, wherein the SIB includes one or more of barring information associated with a second cell or SIB1-related information associated with the second cell and transmitting a SIB1 request to the second cell based at least in part on the received SIB from the first cell.

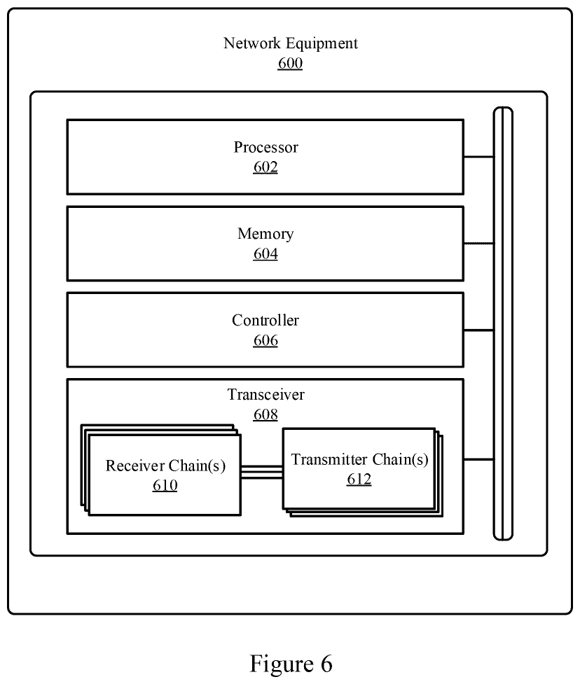

FIG. 6 illustrates an example of a NE 600 in accordance with aspects of the present disclosure. The NE 600 may include a processor 602, a memory 504, a controller 606, and a transceiver 608. The processor 602, the memory 504, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (A SIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604).

For example, the processor 602 may support wireless communication at the NE 600 in accordance with examples as disclosed herein. The NE 600 may be configured to support a means for receiving an indication of a cell reselection procedure for a UE and transmitting, to the UE, a SIB, wherein the SIB includes one or more of barring information associated with a cell or SIB1-related information associated with the cell.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

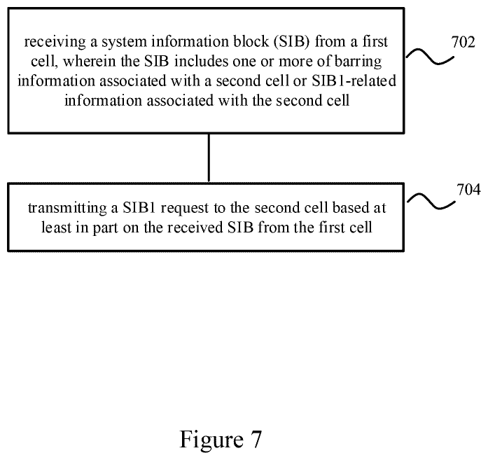

FIG. 7 illustrates a flowchart of a method in accordance with aspects of the present disclosure. The operations of the method may be implemented by a U E as described herein. In some implementations, the UE may execute a set of instructions to control the function elements of the UE to perform the described functions.

At 702, the method may include receiving a SIB from a first cell, wherein the SIB includes one or more of barring information associated with a second cell or SIB1-related information associated with the second cell. The operations of 702 may be performed in accordance with examples as described herein. In some implementations, aspects of the operations of 702 may be performed by a UE as described with reference to FIG. 4.

At 704, the method may include transmitting a SIB1 request to the second cell based at least in part on the received SIB from the first cell. The operations of 704 may be performed in accordance with examples as described herein. In some implementations, aspects of the operations of 704 may be performed by a UE as described with reference to FIG. 4.

It should be noted that the method described herein describes a possible implementation, and that the operations and the steps may be rearranged or otherwise modified and that other implementations are possible.

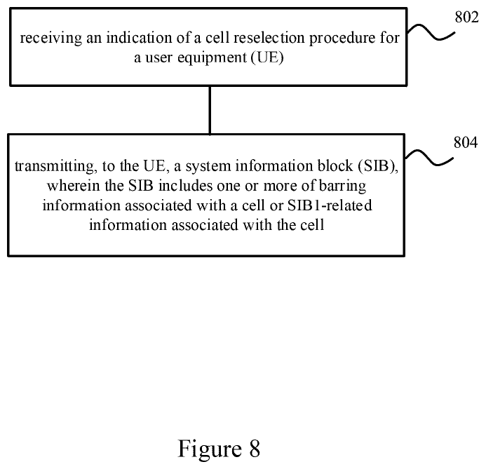

FIG. 8 illustrates a flowchart of a method in accordance with aspects of the present disclosure. The operations of the method may be implemented by an NE as described herein. In some implementations, the NE may execute a set of instructions to control the function elements of the NE to perform the described functions.

At 802, the method may include receiving an indication of a cell reselection procedure for a UE. The operations of 802 may be performed in accordance with examples as described herein. In some implementations, aspects of the operations of 902 may be performed by an NE as described with reference to FIG. 6.

At 804, the method may include transmitting, to the UE, a SIB, wherein the SIB includes one or more of barring information associated with a cell or SIB1-related information associated with the cell. The operations of 804 may be performed in accordance with examples as described herein. In some implementations, aspects of the operations of 804 may be performed by an NE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
receive a system information block (SIB) from a first cell, wherein the SIB includes one or more of barring information associated with a second cell or SIB1-related information associated with the second cell; and
transmit a SIB1 request to the second cell based at least in part on the received SIB from the first cell.

2. The UE of claim 1, wherein the SIB is different than a SIB1, and wherein the SIB comprises a SIB1 request configuration.

3. The UE of claim 1, wherein the barring information associated with the second cell corresponds to information included in a master information block (MIB) of the second cell.

4. The UE of claim 1, wherein the one or more processors are further individually or collectively configured to cause the UE to:
determine that the second cell is not barred based at least in part on the received SIB from the first cell including the barring information associated with the second cell,
wherein the SIB1 request is transmitted to the second cell based at least in part on the second cell not being barred.

5. The UE of claim 1, wherein the one or more processors are further individually or collectively configured to cause the UE to:
receive the SIB from the first cell during a cell reselection procedure.

6. The UE of claim 1, wherein the received SIB from the first cell further includes an infra-frequency reselection indicator (IFRI), and wherein the one or more processors are further individually or collectively configured to cause the UE to:
determine whether the UE is allowed to reselect one or more other cells on a same frequency as the second cell based at least in part on the IFRI; and
refrain from transmission of one or more SIB1 requests to the one or more other cells based at least in part on the UE not being allowed to reselect one or more other cells on the same frequency as the second cell.

7. The UE of claim 1, wherein the SIB1-related information comprises one or more of a public land mobile network (PLMN) identifier, a standalone non-public network (SNPN) identifier, a closed access group identifier (CAG ID), or a tracking area (TA) identifier.

8. The UE of claim 1, wherein the one or more processors are further individually or collectively configured to cause the UE to:
determine that the second cell is a network energy saving (NES) cell,
wherein the SIB1 request is transmitted to the second cell based at least in part on the second cell being the NES cell.

9. The UE of claim 1, wherein the one or more processors are further individually or collectively configured to cause the UE to:
receive SIB1 from the second cell based at least in part on the transmitted SIB1 request; and
camp on the second cell based at least in part on the received SIB1 from the second cell.

10. A network entity for wireless communication, comprising:
one or more memories; and
one or more processors coupled with the one or more memories and individually or collectively configured to cause the network entity to:
receive an indication of a cell reselection procedure for a user equipment (UE); and
transmit, to the UE, a system information block (SIB), wherein the SIB includes one or more of barring information associated with a cell or SIB1-related information associated with the cell.

11. The network entity of claim 10, wherein the network entity is an anchor cell.

12. The network entity of claim 10, wherein the network entity is a serving cell.

13. The network entity of claim 10, wherein the cell is a network energy saving (NES) cell.

14. The network entity of claim 10, wherein the SIB is different than a SIB1, and wherein the SIB comprises a SIB1 request configuration.

15. The network entity of claim 10, wherein the barring information associated with the second cell corresponds to information included in a master information block (MIB) of the second cell.

16. The network entity of claim 10, wherein the SIB1-related information comprises one or more of a public land mobile network (PLMN) identifier, a standalone non-public network (SNPN) identifier, a closed access group identifier (CAG ID), or a tracking area (TA) identifier.

17. The network entity of claim 10, wherein the SIB1-related information associated with the cell includes a bit that identifies whether there are differences between a subset of information elements (IEs) in a SIB1 of the cell and a subset of IEs in the SIB1 of the network entity, and wherein the subset of IEs includes IEs that contain public land mobile network (PLMN) identifiers, tracking area (TA) identifiers, or private network identifiers.

18. The network entity of claim 17, wherein the SIB1-related information associated with the cell includes a bitmap that identifies the differences between the subset of IEs in the SIB1 of the cell and the subset of IEs in the SIB1 of the network entity.

19. A method performed by a user equipment (UE), the method comprising:
receiving a system information block (SIB) from a first cell, wherein the SIB includes one or more of barring information associated with a second cell or SIB1-related information associated with the second cell; and
transmitting a SIB1 request to the second cell based at least in part on the received SIB from the first cell.

20. A method performed by a network entity, the method comprising:
receiving an indication of a cell reselection procedure for a user equipment (UE); and
transmitting, to the UE, a system information block (SIB), wherein the SIB includes one or more of barring information associated with a cell or SIB1-related information associated with the cell.
